(19) United States
(12) Patent Application Publication
(10) Pub. No.: US 2005/0170051 A1
(43) Pub. Date: Aug. 4, 2005

(54) Disposable piping bags and nozzles therefor

(76) Inventor: Jan Folkmar, Weggis (CH)

Correspondence Address: KENNETH M. GARRETT, 392 LAKESHORE ROAD EAST, OAKVILLE, ON, L6J 1J8, CA

(21) Appl. No.: 11/097,330

(22) Filed: Apr. 4, 2005

Related U.S. Application Data
(63) Continuation-in-part of application No. 09/987,042, filed on Nov. 13, 2001.

(51) Int. Cl. A23B 4/00

(52) U.S. Cl. 426/115

(57) ABSTRACT

Piping bags including a nozzle base portion that is inserted into a disposable pouch through the fill opening and pulled into wedged, sealed position within the pouch. The nozzle base portion is provided with surface dislocations which resist the dislodgement of the nozzle base under the influence of various forces to which it is or may be subjected, without resorting to welding or the like. Accordingly, the nozzle may be easily engaged with and removed from the pouch of the piping bag in a domestic or small-scale commercial environment without marring, and re-used with a fresh pouch. The nozzle may also include a cap portion which is selectively matable with the base portion, and which serves inter alia to trap portions of the pouch to resist the dislodgement of the nozzle. The pouch itself may suitably form a security seal where the bag is distributed in a filled condition.

### RELATED APPLICATIONS

This application is a continuation-in-part of application Ser. No. 09/987,042.

### FIELD OF INVENTION

This invention relates to devices commonly referred to as piping bags, pastry bags or icing bags. Such bags are generally filled with a thick, flowable material such as icing, pureed fruit or vegetable, or mayonnaise, which is expressed from the bag through a nozzle, usually to achieve a decorative effect. The invention more particularly relates to disposable piping bags and nozzles therefor.

### BACKGROUND OF INVENTION

Refillable piping bags of the prior art typically include a pouch having an open upper end defining a fill opening, and an open lower end of smaller transverse cross sectional dimension than that of the upper end, defining an outlet end. Typically, the pouch wall is constructed from a durable, impervious fabric that is permanently bonded to a nozzle base at the outlet end, to which base must be selectively connected a nozzle tip of desired cross-sectional shape to provide a pre-determined decorative effect. Improvements relating to such bags are described in the following patent documents:

| | | |
|---|---|---|
| US patents | 5,931,346 | Wallays |
| | 5,026,194 | Lewis |
| | 4,961,517 | Tkac |
| | 4,844,917 | DeLorimiere |
| | 4,776,488 | Gurzan |
| | 4,205,765 | May |
| US Application | 6,179,165 B1 | Knight et al |
| EP Applicaion | 0 757 006 A1 | Ooms |

It is well established that fabric piping bags are usually contaminated with pathogens even after cleansing in a manner to which they would be commonly subject in a domestic or small-scale commercial facility. It is known to provide disposable piping bags in the form of kits. As will be subsequently described in greater detail, one such kit includes a pouch constructed from plastic film having a flat, triangular shape when empty, and which is accordingly similar to that of the reusable fabric bags mentioned above. These disposable bags require a nozzle, which is provided as part of the kit, to be inserted through the fill opening of the pouch, and wedged tightly into the pouch adjacent to the dispensing opening. While disposable bags formed from this kit are generally suited for small-scale domestic use, they are inappropriate for large-scale commercial use or for distribution in a filled condition. A difficulty associated with this kit is that of retaining the nozzle in its wedged, sealed position within the pouch, due to a reactive force exerted by the pouch upon the conically inclined surface of the nozzle. In practice, a further dislodging force may often arise due to inadvertence; typically, when filling the bag, the nozzle may contact a support surface such as a kitchen counter-top, whereby the nozzle is pushed towards the interior of the bag. These problems are likely to be even more acute where the bags are intended for commercial or professional use, as the thickness of the pouch will usually be greater and the bags will generally be larger and heavier. Moreover, while the pouches are intended to be disposable following their use, it may be preferred that the nozzles be re-used, in which case stainless steel may be a preferred material of construction, although plastic nozzles may also be preferred in some instances, for example where a kit comprises a small plurality of pouches and a single nozzle which is intended to be disposed of upon the exhaustion of the supply of pouches. The coefficient of friction between stainless steel and most plastic materials that are of likely interest for forming a disposable pouch is relatively low, and it has not been practical heretofore to provide disposable pouch type piping bags with stainless steel nozzles, and nozzles of this type are not known for use other than with cloth type bags, wherein both the bag and the nozzle are provided with complimentary coupling rings.

It is also known to distribute pre-mixed cake icing which is hermetically sealed within a collapsible plastic tube having an outlet unitarily formed therewith. Such tubes are relatively small, and are intended for a single use. The tubes have a nipple-like outlet end, and the user makes the outlet opening by cutting off the end of the nipple with scissors or the like. There is no provision for coupling these bags to nozzle caps of different cross sections or for closing the tubes once they have been opened.

In order to be economically viable, disposable pastry bags should be inexpensive to produce and distribute, and they should not significantly increase the cost of production of the various types of substances that may be sealed and distributed in the bags.

In the aforesaid prior art Ooms patent document, there is disclosed a disposable pastry bag which is suited for commercial use for the distribution of various pasty-like filling materials. The pastry bag comprises a conical plastic film pouch within which there is disposed a nozzle base that is retained in position within the pouch by spot-welding. The process of welding is normally considered to involve a coalescence of the surfaces of the materials being welded: see, for example, Marks' STANDARD HANDBOOK FOR MECHANICAL ENGINEERS (McGraw-Hill), and Van Nostrand's Scientific Encyclopedia. As such, the removal of the pouch from the nozzle of the Ooms pastry bag would normally be accomplished by a localized tearing of the film of the pouch, and the nozzle would not be available for re-use. Moreover, any method for the assembly of a pastry bag using a disposable film pouch that involves welding is clearly not applicable where the nozzle is manufactured from stainless steel, and is of little practical interest where it is desired to form pastry bags from a kit in a domestic or small-scale commercial environment.

It is an object of this invention to provide pastry bags comprising a disposable pouch and a re-usable nozzle therefor that may be retained within the pouch solely by frictional means, which term as used throughout this specification does not include welding of any type.

It is another object of this invention to provide pastry bags utilizing disposable pouches in the form of a kit of parts that is suitable for domestic assembly without the use of any specialized equipment.

It is still another object of this invention to provide pastry bags utilizing disposable film pouches and stainless steel nozzles, and to provide stainless steel nozzles therefor.

It is yet another object of this invention to provide economic kits to facilitate the easy and convenient assembly of disposable, piping bags from disposable pouches and nozzles that may be re-used.

### SUMMARY OF THE INVENTION

In accordance with one aspect of this invention, a disposable piping bag comprises a pouch with an expressible, viscous medium sealed therein. The pouch is constructed from a thin, flexible material, with plastic film being particularly suited and preferred, so as to collapse on the expression of the medium from the pouch. The pouch has a neck portion adjacent one axial end thereof having conically reducing transverse cross-sections, and is devoid of any structural means such as is commonly found in re-usable type pouches that will co-act with cooperating means on the nozzle that serve to unite the nozzle and the pouch in sealed relationship. The piping bag of the invention further comprises nozzle means including a funnel-like base having an upper rim that comprises conically inclined wall portions extending from adjacent the upper rim to connect in flow relationship with a spout portion. The nozzle base is disposed at least in part within the pouch with neck portions thereof in gripping, relationship with the conically inclined wall portions of the nozzle base so as to create a seal therewith.

Suitably and preferably, the conically inclined portions of the nozzle base are generally smooth walled on their outwardly facing surface, so as to provide a good area of sealing contact between the nozzle base and the pouch. Over a period of time, it is found that the sealing contact between the pouch and the nozzle base is reduced, due at least in part to reactive forces generated by the pouch that tend to urge the base from its sealing contact with the walls of the pouch. This problem may be particularly acute when the medium contained within the pouch has a high fat or oil content, such as mayonnaise or whipped butter, for example. Accordingly, the conically inclined wall portions of the nozzle base portion are provided with surface dislocations thereon which function to counteract these reactive forces. Preferably, the dislocations are raised on the conical walls of the nozzle base, although they may also comprise or include surface indentations, particularly where the pouch is shrunk into the nozzle base, or where one or more constrictive elements are used to clamp the pouch wall to the nozzle base.

Persons skilled in the manufacturing arts will appreciate that raised dislocations or indentations will, in effect, provide undercut surfaces onto which the material of the pouch may key, without being bonded thereto. Suitably, the dislocations extend arcuately across the surface of the conical walls. In accordance with the preferred, illustrative embodiment, the surface dislocations comprise several discrete, which is to say non-interconnected, axially spaced apart, annular bands raised on the surface of the base portion, but it will be understood that the number and type of dislocations may vary widely and that they may be selected in accordance with different factors such as the conical angle of the base portion of the nozzles, and the materials of construction of the nozzle and the pouch so as to provide the desired gripping and sealing retention of the nozzle base within the pouch.

Where the piping bag is intended to be distributed or stored for a relatively long period in a filled condition, the nozzle means may further comprise a nozzle cap disposed outside of the pouch, and the nozzle base and the nozzle cap will suitably include complementary coupling means for selectively coupling the nozzle cap to said nozzle base, with portions of the pouch trapped therebetween, thereby serving to prevent the accidental dislodgement of the nozzle base from its gripped condition within the pouch.

Suitably and preferably, the piping bag may comprise a selection of nozzle caps, and include, for example a cap which may be used to close the outlet opening of the nozzle base when an open bag is stored for a period of time, and one or more elongated caps with a bore therethrough to thereby form nozzle tips of different cross-sections to provide different artistic effects when extruding piping material from the bag.

Suitably and preferably also, in a commercial application of the invention, security seal means will be provided to close the outlet of the spout portion to prevent tampering of the medium contained in the pouch.

Where the piping bag is intended to be filled by an end-user, and where the nozzle base is provided with the above-mentioned surface dislocations, the gripping action of the pouch on the nozzle base may be such that the cap is not necessary, even where the nozzle base is made from a material with a low coefficient of friction such as stainless steel, and accordingly, the cap may be omitted.

The preferred means for coupling the nozzle cap to the nozzle base comprises thread means, suitably with male threads disposed on the spout portion of the nozzle base and female threads disposed on the cap, although other coupling means including snap couplings, for example, may be employed.

Given that the pouches at least of the piping bags are intended to be disposable, it is necessary that they be of relatively low cost. One of the preferred features of a piping bag intended to be filled by the user is a resealable closure for the filling end of the bag, preferably of the push together zip type. Where the pouch has a triangular shape when flat, the length of the fill opening for a given bag volume tends to be rather high, and given the relatively high cost of zip-type resealable closures, this would be a burdensome factor. A still further cost factor associated with resealable triangular pouches is in the material wastage in manufacture. Generally speaking, a film pouch will be manufactured from two overlaying bands of film that are fused together to define the margins of the pouch. Where a resealable zip type closure is required, this will normally be molded along one lateral margin of the sheets only. Accordingly, approximately one half of the sheet material will be wasted when the pouches are formed in this manner. Yet another disadvantage associated with the triangular pouches is in the difficulty in assessing the amount of material within the pouch, as this will vary in a non-linear manner with the height of the material in the pouch. In accordance with one aspect of this invention, pouches for use with piping bag assemblies have an elongated, pentagonal form. Pouches of this form offer improvements over the triangular form pouches in each of the above areas, and are also advantageous for the user in facilitating the expression of medium from the bag, particularly where the bags are relatively large. This type of bag has a still further advantage in that it is readily manufactured and distributed in a web, to facilitate its handling by an industrial user in automated fill equipment.

Having described the broad aspects of the invention, it will be further described in relation to presently preferred embodiments thereof, from which still further objects, aims and advantages of the invention will become apparent.

### BRIEF DESCRIPTION OF THE DRAWINGS

FIG. 1 shows in elevation an exploded fragmentary view of a prior art disposable piping bag arrangement;

FIG. 2 shows in elevation a filled piping bag in accordance with the invention, broken to indicate indefinite length and cut away to reveal detail;

FIG. 3 shows in longitudinal cross-section the first part of a nozzle means as used in the arrangement of FIG. 2;

FIG. 4 shows in longitudinal cross-section a second part of a nozzle means which may be coupled to the first part as an alternative to the second part shown in FIG. 2;

FIG. 5 shows in elevation a film pouch of a type used in the assembly of FIG. 2;

FIG. 6 shows a film web in which pouches such as that seen in FIG. 5 are formed;

FIG. 7 shows a cross-section on line 7-7 of FIG. 6; and

FIG. 8 is similar to FIG. 3, but shows the addition of a security seal thereto.

### DESCRIPTION OF THE PREFERRED EMBODIMENT

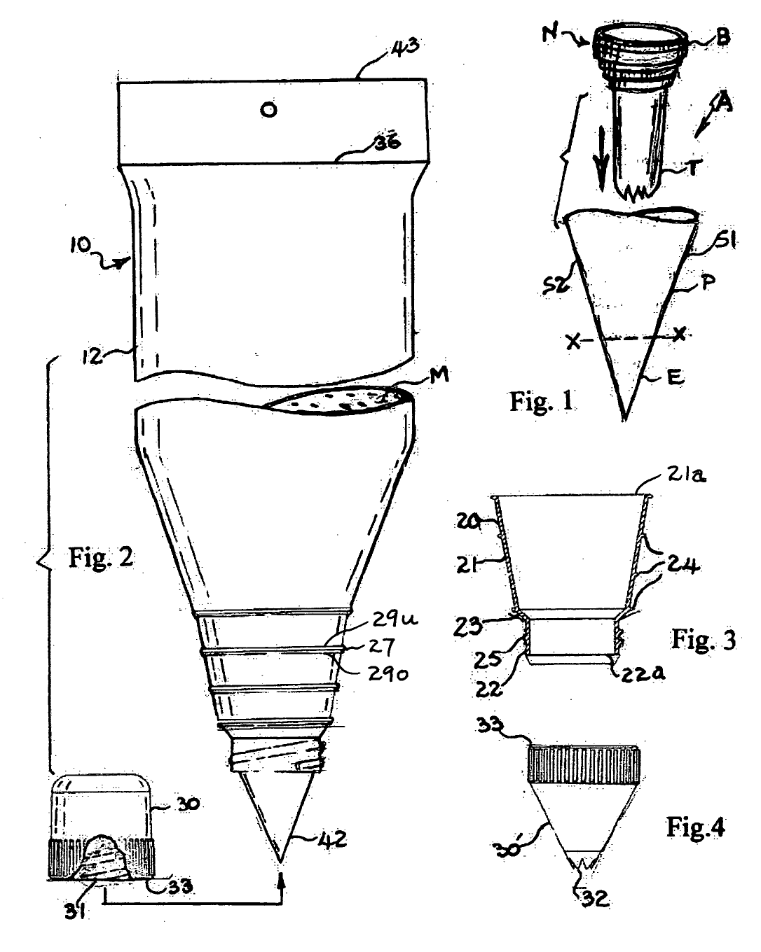

Referring to the drawings in detail, a prior art piping bag assembly as seen in FIG. 1 is identified generally therein by the letter A. Assembly A includes a plastic film pouch P which comprises a pair of overlying film sheets F1, F2 joined together along convergent sides S1 S2 to form a nipple at end E. Only the lower portion of pouch P is illustrated, but it is to be understood that sides S1, S2 are continuously divergent from end E to the upper edge of pouch P, the pouch having a triangular form as is common with fabric pastry bags of the prior art. Assembly A further comprises a nozzle N including a stepped, frusto-conical base portion B and unitarily formed therewith, a tip portion T. Prior to the assembly of pouch P and nozzle N, a user is instructed to sever end E along line X-X so as to provide an opening through which the tip portion T of nozzle N will project when the nozzle is passed through the pouch from the upper end. Tip portion T is then pulled from below the pouch, so as to engage base portion B in wedged, sealed relationship with the walls of the pouch. Over a period of time, the reactive force generated by pouch P on nozzle base B will tend to urge the nozzle base out of its sealing relationship with the pouch, and leakage of medium contained within the pouch will occur. This problem is particularly acute when the medium has significant oil or fat component, such as mayonnaise or whipped butter.

FIGS. 2 and 3 illustrate the improved piping bag assembly of the invention, which is identified therein generally by the numeral 10. Assembly 10 comprises a pouch 12, and a nozzle means comprising a first part 20, best seen in FIG. 3. First part 20 is broadly funnel shaped and includes a base portion 21, which is upwardly outwardly divergent in a frusto-conical form to terminate at rim 21a. First part 20 connects rim 21a in flow relationship with a right circular tubular spout 22 having an outlet 22a, and a transitional downwardly, inwardly, inclined shoulder 23 therebetween. Base portion 21 is circumscribed with a plurality of annular ribs 24 raised thereon in parallel, axially spaced apart relationship, which ribs serve to strengthen the wall, and which also have an additional purpose that will be subsequently referred to. Ribs 24 define a crest portion 27 and an upper, undercut shoulder surface 29u and a lower, overhung shoulder surface 29o, as viewed from spout 22. Tubular spout 22 has a male thread 25 raised thereon.

The nozzle of assembly 10 suitably includes a second part 30 which may be in the form of a closed cap, as seen in FIG. 2, which cap has a female thread 31 formed therein to be connectable with male thread 25.

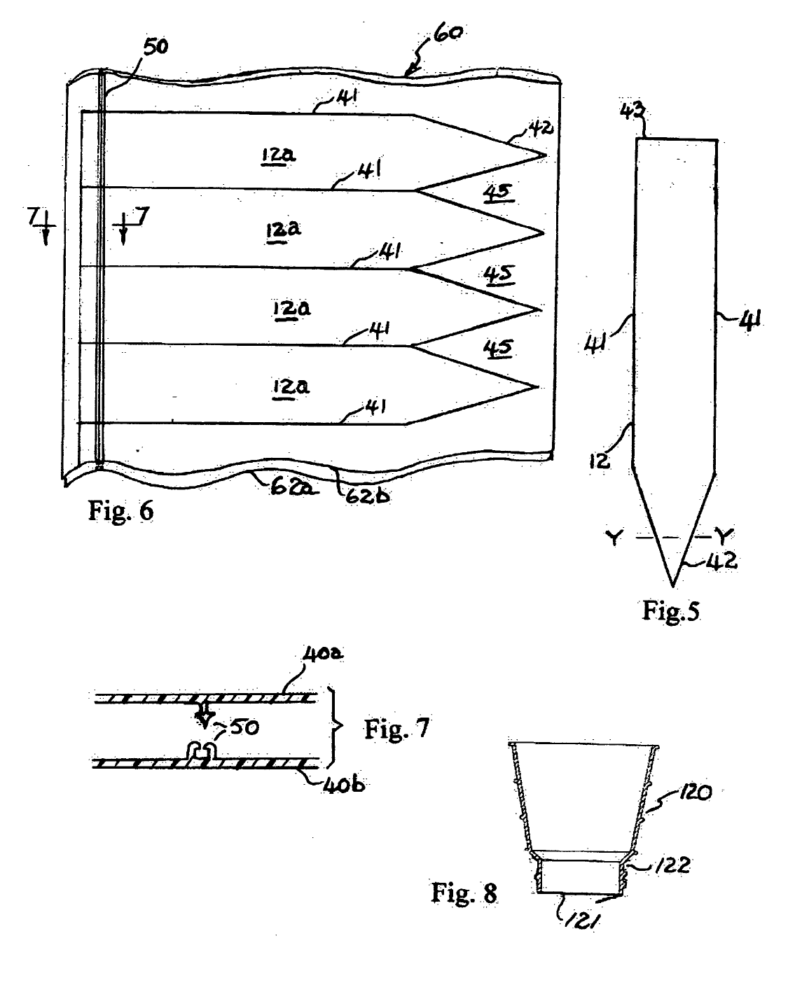

Pouch 12 in its unfilled condition, as best seen in FIGS. 5, 6 and 7 comprises a pair of flat film walls 40a, 40b, sealed together along laterally extending edges 41. Edges 41 are suitably parallel over the upper, major portion of pouch 12, and then converge to terminate in a nipple 42, in effect having an elongated pentagonal shape. The upper end 43 of pouch 12, in its flat, unfilled condition is open, to permit the first part 20 of the nozzle means to be inserted into the pouch, and urged towards nipple 42, so causing the pouch to deform at least initially in an elastic manner in which it tightly grips and surrounds first nozzle part 20 in sealing relationship therewith. Suitably and preferably, the conical angle of the convergent wall portions of pouch 12 is suitably and preferably the same as that of base portion 21, so as to enhance the gripping and sealing action of the walls of pouch 12 on first nozzle part 20. It will be appreciated that the film wall of pouch 12 will be in greatest tension where it passes over the crest 27 of ribs 24. Most of the force generated by such contact will be radial, tending to provide a strong seal between nozzle 20 and the pouch, with very little reactive force generated in an axial direction between the crest and the pouch material. Where the pouch 12 contacts the shoulder portions 29u, 29o, primarily axial force components will be generated, with the axial force generated on the undercut shoulder portion 29u tending to urge the first nozzle part 20 outwardly from the pouch, and that generated at the overhung shoulder portion 29o acting in opposition. In view of the conical taper of nozzle portion 20, the undercut surface will be greater than that of an associated overhung surface, and the net reactive force in the axial direction will tend to urge the nozzle portion outwardly from the pouch. Accordingly, when first nozzle portion 20 is properly positioned in pouch 12, there will be little likelihood of leakage occurring between the pouch wall and nozzle part 20, and the nozzle part will tend to remain in position within the pouch.

Following the sealing engagement of first nozzle part 20 with the wall of pouch 12, cap 30 will be coupled to the first nozzle part, thereby trapping portions of the pouch wall between the cap and the first nozzle part, following which pouch 12 may be filled with a filling medium M and hermetically closed along seal line 36. It should be emphasized here that cap 30 does not function at this stage to seal piping bag assembly 10 in any manner, and that the assembly could be distributed with the cap in an uncoupled state. However, it is preferred that the two nozzle parts be coupled together, as the second part serves to protect nipple 42 from mechanical damage. Still further, it serves to prevent the dislodgement of nozzle first part 20 from its sealing engagement with the wall of pouch 12 and its migration into the mass of filling medium M. Shrinking the pouch 12 onto the first nozzle part 20 may also serve to prevent the dislodgement of the nozzle first part. To this end, film walls 40a, 40b may be formulated to facilitate for example, thermal shrinkage, as is known in the art. Still other means of shrinkage may be used and may under some circumstances be preferred.

The user of filled, sealed assembly 10 is instructed to use the assembly by removing cap 30, and, following a visual inspection to determine that nipple 42 has not been tampered with, to sever the nipple marginally below shoulder 23. This will then permit filling medium M to be expressed from pouch 12 through the tubular outlet 22a of the first nozzle part 20. Should it be desired, assembly 10 might include one or more second nozzle parts, an exemplary alternative such part being seen in FIG. 4 and identified therein by the numeral 30′. It will be understood that nozzle second part 30′ may conveniently be coupled to first part 20 in an identical manner to that in which cap 30 is coupled, to permit piping of a different cross section to be extruded from assembly 10 through decorative tip 32. Irrespective of the precise nature of nozzle second part 30, it is desirable that when it is secured to the nozzle first part, it will trap a portion of the film wall of pouch 12 between the two nozzle parts, to reduce the possibility of the accidental dislodgement of the first nozzle part 20 as earlier spoken of Conveniently, following the removal of nipple 42, this trapping action will arise between the upper peripheral end 33 of second nozzle part 30 and shoulder 23. When a user has partially used the filling medium M contained in piping bag assembly 10, closed cap 30 may be coupled with first nozzle part 20 to seal the contents of assembly 10 for storage and subsequent reuse if desired.

Assembly 10 as thus far described, is particularly suited for use in a commercial filling and sealing operation, although it is by no means limited thereto. Where assembly 10 is intended for sale to an end user in an unfilled condition, a modified pouch 12a, best seen in FIGS. 6 and 7 may be provided. Pouch 12a has a releasable closure means 50 at the upper end thereof Conveniently, closure 50 comprises a zip fastener of a type commonly used in food storage bags, such as a push together or a slide fastener.

Pouches 12 and 12a are typically manufactured from a web 60 comprising two continuous, overlaying bands 62a, 62b of food grade plastic film by fusing the film together to form the side margins 41 of the pouches, with each pouch having a side margin in common with an adjacent pouch. The pouches 12 or 12a so formed may suitably remain in the web 60 to facilitate the packing and handling of the pouches at a filling station, and thereby reduce handling costs.

Where, as is particularly illustrated in FIG. 6, bands 62a, 62b include closure elements 50, these are suitably provided along one longitudinal side of the bands only, to reduce the cost of production of the bands. This leads to some material wastage, as the films portions 45 will be discarded. In practice such wastage is less than about five percent of web 60. In comparison, were triangular shape pouches to be formed in web 60, the wastage would be approximately fifty percent, and the cost of the closure elements 50 for a pouch of a given volume would be appreciably higher than it is for the elongated pentagonal pouch 12a.

While in the first embodiment of the invention the nipple end 42 of pouch 12 serves to enclose spout opening 22a and thereby form a security seal for the contents M contained within piping bag 10, this arrangement may be changed if desired. Thus, as seen in FIG. 8, in a nozzle first part 120, a security seal 121 is provided at the outlet end of spout portion 122. Optionally, pouch 12 may be prepared at the time of its manufacture by severing nipple end 42 along the line Y-Y, which will permit the spout portion 122 of nozzle first part 120 to project through pouch 12 when assembled therewith.

It will be understood that the foregoing embodiments are exemplary only of the invention, and that many changes thereto may be made within the scope of the claims appended hereto.

1. A disposable piping bag comprising a thin, flexible plastic film pouch with an expressible, viscous medium sealed therein, said pouch collapsing on the expression of said medium therefrom; said pouch having a neck portion adjacent one axial end thereof having a conically reducing transverse cross-section; and
a nozzle including a funnel-like nozzle base portion having an upper rim, comprising conically inclined wall portions extending from adjacent said upper rim and a spout portion connected in flow relationship therewith;
wherein said conically inclined wall portions are provided with surface dislocations thereon;
said nozzle being disposed at least in part within said pouch with neck portions thereof held in gripping, non-coalescent relationship with said conically inclined wall portions so as to create a seal thereon, with said surface dislocations tending to create a net reactive force generated by the interaction of said pouch therewith tending to urge said nozzle outwardly from said pouch.

2. A disposable piping bag as set forth in claim 1 wherein said surface dislocations have at least one undercut surface associated therewith.

3. A disposable piping bag as set forth in claim 2 further comprising a nozzle cap disposed outside of said pouch;
said nozzle base portion and said nozzle cap including complementary coupling means for selectively coupling said nozzle cap to said nozzle base portion with portions of said pouch trapped therebetween.

4. A disposable piping bag as set forth in claim 3 wherein said conically inclined wall portions of said nozzle are inclined at the same conical angle as said reducing neck portion of said pouch.

5. A disposable piping bag as set forth in claim 3 characterized wherein said nozzle cap is elongated and has a bore therethrough to form a nozzle tip.

6. A disposable piping bag as set forth in claim 1 wherein said nozzle is circumscribed by a shoulder adjacent said spout portion, and wherein said cap serves to trap portions of said pouch against said shoulder.

7. A disposable piping bag as set forth in claim 2 characterized wherein said nozzle base portion is constructed of stainless steel.

8. A disposable piping bag as set forth in claim 1 characterized wherein said surface dislocations are in the form of a plurality of discrete, radially outwardly extending, axially spaced apart ribs.

9. A disposable piping bag as set forth in claim 8 wherein at least one of said ribs circumscribes said nozzle conical wall portions

10. A kit for forming a disposable piping bag comprising, in association, a pouch formed from a thin, flexible material expandable between a flat, generally two dimensional form when empty and a three dimensional form when filled, said pouch having axially opposed ends, one said end defining a fill opening for said pouch, the opposed end defining an outlet end;
said outlet end having a progressively diminishing width therealong;
a nozzle means comprising a base portion dimensioned to permit its insertion into said pouch through said fill opening and to be snugly received in said outlet end of said pouch in tightly gripped relation therewith;
wherein said base portion comprises a truncated conical portion extending from adjacent to the upper rim of said base portion with a progressively reducing diameter therealong, and is provided with surface dislocations thereon that will serve to enhance the gripping interaction between said pouch and said nozzle means and to counter reactive forces generated on said nozzle means by said pouch which tend to urge said nozzle means from its gripping interaction with said pouch.

11. A kit for forming a disposable piping bag as set forth in claim 10 wherein said surface dislocations define at least one undercut surface as viewed from the outlet of said nozzle means.

12. A kit for forming a disposable piping bag as set forth in claim 10 wherein said dislocations comprise a plurality of discrete, axially spaced apart ribs circumscribing said conical portion.

13. A kit for forming a disposable piping bag as set forth in claim 12 wherein said outlet end of said pouch diminishes at a conical angle equal to that of said truncated conical portion of said base portion.

14. A kit for forming a disposable piping bag as set forth in claim 10 wherein said nozzle means includes a nozzle cap portion selectively engageable with said nozzle base portion, and wherein said cap portion when engaged will serve to trap a portion of said pouch between said cap portion and said nozzle base portion.

15. A kit for forming a disposable piping bag as set forth in claim 10 wherein said pouch has a relatively constant radial cross section in upper portions thereof.

16. A kit for forming a disposable piping bag as set forth in claim 10 wherein said pouch is disposed in a web.

17. A kit for forming a disposable piping bag as set forth in claim 10 wherein said nozzle base portion is formed from stainless steel.

18. A stainless steel nozzle means suitable for use with a disposable film pouch devoid of any structural means for attachment to the nozzle means to form therewith a piping bag, said nozzle means having an upper rim and an outlet, and wall portions defining in part said nozzle means comprising a truncated conical wall extending from adjacent said rim towards said outlet, and a plurality of surface dislocations disposed on said conical wall to form undercut surfaces.

19. A stainless steel nozzle means for use with a disposable film pouch to form a piping bag, as defined in claim 18 wherein said surface dislocations comprise a plurality of small lands raised on said conical wall.

20. A stainless steel nozzle means for use with a disposable film pouch to form a piping bag, as defined in claim 19 wherein said lands comprise a plurality of discrete ribs encircling said conical wall at axially spaced apart intervals thereon.
